(19) United States
(12) Patent Application Publication
(10) Pub. No.: US 2025/0358490 A1
(43) Pub. Date: Nov. 20, 2025

(54) METHOD, APPARATUS, DEVICE AND STORAGE MEDIUM FOR CONTENT GENERATION

(71) Applicant: Beijing Zitiao Network Technology Co., Ltd., Beijing (CN)

(72) Inventors: Honghao Zeng, Beijing (CN); Shouyao Wang, Beijing (CN)

(21) Appl. No.: 19/210,767

(22) Filed: May 16, 2025

(30) Foreign Application Priority Data
May 17, 2024 (CN) 202410620834.6

(51) Int. Cl. H04N 21/81; H04N 21/2662; H04N 21/431

(52) U.S. Cl. CPC H04N 21/816; H04N 21/2662; H04N 21/4316; H04N 21/4318

(57) ABSTRACT

According to embodiments of the disclosure, there are provided a method, an apparatus, a device, and a computer-readable storage medium for content generation. The method includes: in response to a target material being selected for content generation, presenting a preview area and an interactive element for the target material, the preview area including a visual content associated with at least a part of the target material, the interactive element corresponding to a sub-area of the preview area to indicate a selected part of the target material; receiving an operation on at least one of the preview area or the interactive element; and in response to completion of the operation, determining a target part for content generation in the target material. Therefore, the convenience and efficiency of material selection can be improved in content generation.

### CROSS-REFERENCE

This application claims the benefit of Chinese Patent Application No. 202410620834.6 filed on May 17, 2024, entitled “METHOD, APPARATUS, DEVICE, AND STORAGE MEDIUM FOR CONTENT GENERATION”, which is hereby incorporated by reference in its entirety.

### FIELD

Example embodiments of the present disclosure generally relate to the field of computers, and in particular, to methods, apparatuses, devices, and computer-readable storage media for content generation.

### BACKGROUND

With the development of computer technologies, media content such as audio and video play an increasingly important role in daily life of people. In some cases, the user may edit some materials to generate the desired content. For example, the user may adjust the material through a multi-track editing technology to generate the content meeting the demand. Therefore, a more convenient and accurate editing technology is expected to meet the user's adjustment requirements.

### SUMMARY

In a first aspect of the present disclosure, there is provided a content generation method. The method comprises: in response to a target material being selected for content generation, presenting a preview area and an interactive element for the target material, the preview area comprising a visual content associated with at least a part of the target material, the interactive element corresponding to a sub-area of the preview area to indicate a selected part of the target material; receiving an operation on at least one of the preview area or the interactive element; and in response to completion of the operation, determining a target part for content generation in the target material.

In a second aspect of the present disclosure, there is provided an apparatus for content generation. The apparatus comprises: an element presenting module configured to present, in response to a target material being selected for content generation, a preview area and an interactive element for the target material, the preview area comprising a visual content associated with at least a part of the target material, the interactive element corresponding to a sub-area of the preview area to indicate a selected part of the target material; an operation receiving module configured to receive an operation on at least one of the preview area or the interactive element; and a target part determining module configured to determine, in response to completion of the operation, a target part for content generation in the target material.

In a third aspect of the present disclosure, there is provided an electronic device. The device comprises at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, there is provided a computer-readable storage medium. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 illustrates a schematic diagram of an example of a selection interval and a placement interval;

FIGS. 3A-3C illustrate schematic diagrams of example interfaces for content generation according to some embodiments of the present disclosure;

FIG. 4 illustrates a schematic diagram for rendering an auditory preview area according to some embodiments of the present disclosure;

FIG. 5 illustrates a flowchart of a process of content generation according to some embodiments of the present disclosure;

FIG. 6 illustrates a block diagram of an apparatus for content generation according to some embodiments of the present disclosure; and

FIG. 7 illustrates a block diagram of a device capable of implementing a plurality of embodiments of the present disclosure.

### DETAILED DESCRIPTION

It can be understood that, before the technical solutions disclosed in the embodiments of the present disclosure are used, the types, the usage scope, the usage scenario and the like of personal information related to the present disclosure should be notified to the user in an appropriate manner according to the relevant laws and regulations and the authorization of the user should be obtained.

For example, in response to receiving an active request from a user, prompt information is sent to the user to explicitly prompt the user that the requested operation will need to acquire and use the personal information of the user. Therefore, the user may be enabled to autonomously select whether to provide personal information to software or hardware executing the operation of the technical solution of the present disclosure, such as an electronic device, application, a server or a storage medium, according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners meeting related laws and regulations may also be applied to implementations of the present disclosure.

It may be understood that the data involved in the technical solution (including but not limited to the data itself, the acquisition or use of the data) should follow the requirements of the corresponding laws and regulations and related specifications.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be comprised in any section/subsection. Furthermore, the embodiments described in any section/subsection may be combined in any manner with any other embodiment described in the same section/subsection and/or different sections/subsections.

Herein, unless explicitly stated, “responding to A” performs one step and does not imply that this step is performed immediately after “A”, but may comprise one or more intermediate steps.

In the description of the embodiments of the present disclosure, the terms “comprising/including” and the like should be understood as open-ended inclusion, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

### Example Environment

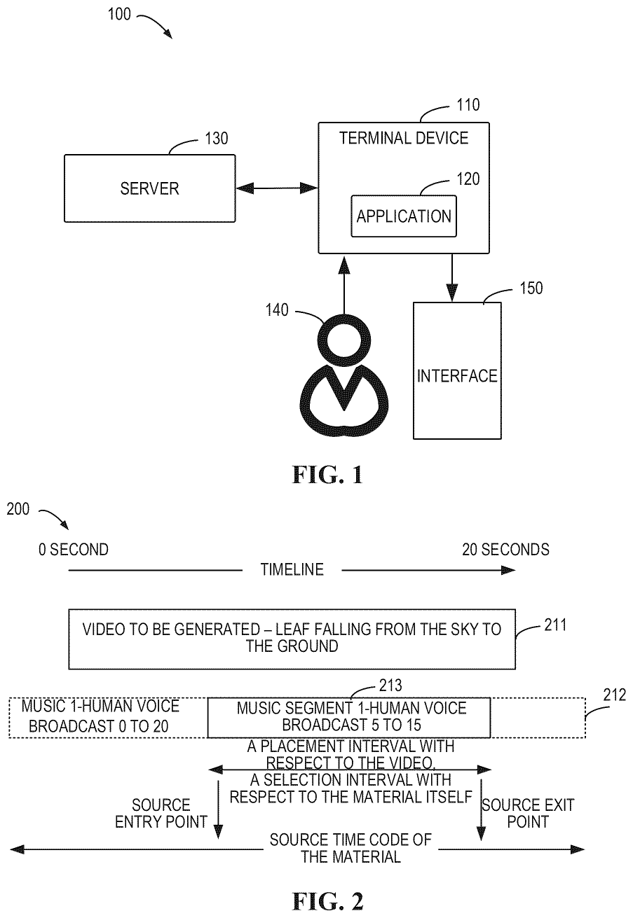

FIG. 1 illustrates a schematic diagram of an example environment 100 in which embodiments of the present disclosure may be implemented. In the example environment 100, an application 120 is installed in a terminal device 110. The user 140 may interact with the application 120 via the terminal device 110 and/or an attachment device of the terminal device 110.

In some embodiments, the application 120 may be a content sharing application, a content editing application, a content creating application, or the like. The application 120 may provide various services related to media content (which may also be referred to as media content items, content items, media items, etc.) to the user 140, including browsing, commenting, forwarding, creating (e.g., taking pictures and/or editing), publishing, and the like of the media content.

In environment 100 of FIG. 1, if application 120 is active, terminal device 110 may present an interface 150 of the application 120. The interface 150 may include various interfaces that can be provided by the application 120, such as a media content presenting interface, a media content creating interface, a media content release interface, and the like. The application 120 may provide a media content editing function (e.g., the application 120 may be a clipping-like application) to support editing (e.g., clipping) the media content in the application 120.

In some embodiments, the terminal device 110 communicates with a server 130 to enable provisioning of services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, etc.). The server 130 may be various types of computing systems/servers capable of providing computing power, including, but not limited to, a mainframe, an edge computing node, a computing device in a cloud environment, and the like.

It should be understood that the structures and functions of the various elements in the environment 100 are described for exemplary purposes only and do not imply any limitation to the scope of the present disclosure.

According to the embodiments of the present disclosure, a user may more intuitively, conveniently and accurately adjust a selection interval of the audio and video segments without affecting a fixed placement interval. For ease of understanding, a selection interval and a placement interval in the content generation process of the present disclosure are described below with reference to FIG. 2. FIG. 2 illustrates a schematic diagram of an example 200 of the selection interval and the placement interval.

The selection interval refers to a time period 213 (e.g., music segment 1-human voice broadcast 5 to 15) selected from the original material file 212 (e.g., music 1-human voice broadcast 0 to 20) for generating a particular segment of content 211 (e.g., a video project to be generated). The interval is defined based on the original time code of the material by setting a source entry point and a source exit point. It determines which part of the material is to be imported into the content 211.

For example, if there is a video file of 10 minute long, but the user only wants to use a segment from the 2nd minute to the 4th minute, the source entry point that the user may set is the 2nd minute and the source exit point that the user may set is the 4th minute. Therefore, the selection interval of the user is a time period from the 2nd minute to the 4th minute, that is, this part of the video will be selected for further editing and processing.

The placement interval refers to a specific position of a material corresponding to a time period 213 selected from the original material file 212 on a final content (for example, a video project to be generated) or a timeline. The interval does not relate to the content of the material itself, but relates to the position of the starting and ending time points at which the selected material is scheduled to play in the entire content 211 (e.g., the video project to be generated).

For example, assume that the user is making a 15 minutes video project and decide to place the selected video segment of the 2nd minute to the 4th minute at the 5th minute of the project to start playing. If the playing rate of the segment does not change, it ends at the 7th minute. Therefore, the placement interval of the segment of the material is from the 5th minute to the 7th minute of the project.

As briefly described above, based on the current audio and video multi-track editing technology, the adjustment of the selection interval of the segment in the fixed placement interval is usually a complex and unintuitive process. For example, the user needs to adjust the placement interval and the selection interval of the material by operating the left and right controls of the segment. Then, by long pressing and moving the segment, is the user attempts to precisely align it to the original placement interval.

In this way, however, the accuracy of the adjustment is insufficient. For example, it is difficult to accurately match the adjusted selection interval with the original placement interval. The operation of adjustment by the user is cumbersome. For example, in order to approach the original placement interval as close as possible, the user may need to perform long-pressing and fine-tune operations for a plurality of times. Further, it is inconvenient for the user to perform sound adjustment. For example, when processing an audio segment, the user cannot intuitively locate and analyze whether the audio on the adjusted selection interval meets the expected effect, and the user usually needs to identify the audio segment through repeated adjustment, dragging and playing operations.

In view of the above, embodiments of the present disclosure provide an improved solution for content generation. According to various embodiments of the present disclosure, if the target material is selected for content generation, the terminal device presents a preview area and an interactive element for the target material. The preview area includes a visual content associated with at least a part of the target material, the interaction element corresponding to a sub-area of the preview area to indicate a selected part of the target material. The terminal device receives an operation on at least one of the preview area or the interactive element. Then, in response to a completion of the operation, the terminal device determines a target part for content generation in the target material. Therefore, the convenience and efficiency of material selection in content generation may be improved.

Some example embodiments of the present disclosure will be described below with continued reference to the accompanying drawings. Hereinafter, an example embodiment will be described mainly with respect to the terminal device 110. It should be understood that the actions described with respect to the terminal device 110 may be performed by the application 120 on the terminal device 110, or may be performed by the application in cooperation with a serving end (for example, a server) thereof.

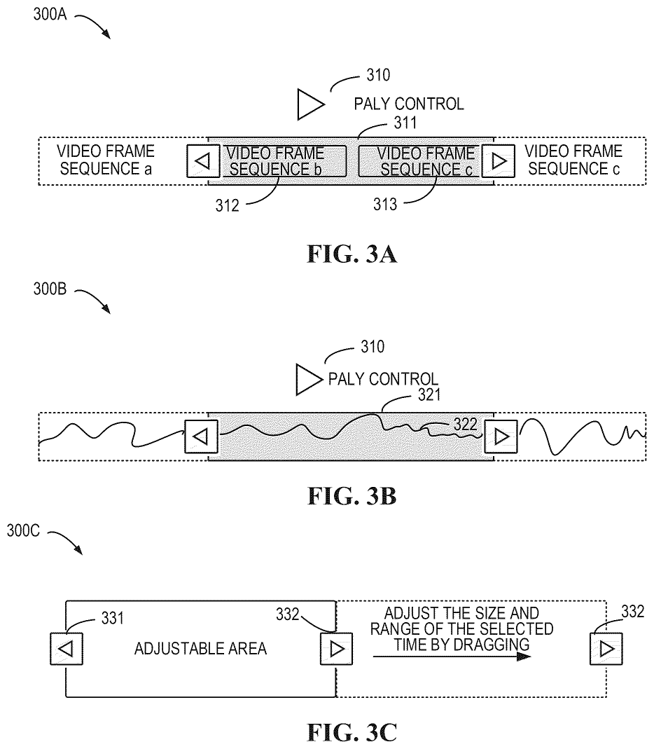

A schematic diagram of the present disclosure for content generation will be described below with reference to FIGS. 3A-3C. FIGS. 3A-3C illustrate schematic diagrams 300A-300C for content generation according to some embodiments of the present disclosure.

In some embodiments, in response to the target material being selected for content generation, the terminal device 110 presents the preview area and the interactive element for the target material. The user 140 selects the target material in the application 120 to generate the corresponding content. The terminal device 110 may present a preview area and an interactive element for the target material.

The target material may include various types of content. In some embodiments, the target material may include a video. Alternatively, or additionally, the target material may include an audio. In some embodiments, the preview area includes a visual content associated with at least a part of the target material.

In some examples, if the target material includes a video, the visual content included in the preview area includes at least a portion of the frames of the video. The at least a portion of the frames included in the visual content may be selected according to a certain time interval. If the target material selected for content generation by the user includes an audio, the visual content included in the preview area includes a waveform corresponding to at least a part of the audio.

It may be understood that, if the target material selected for content generation by the user includes a video, the visual content included in the preview area includes at least a portion of the frames of the video, and the preview area at this time may be referred to as a visual preview area.

As shown in the schematic diagram 300A of FIG. 3A, the visual content in a visual preview area 311 includes at least a portion of the frames of the video. For example, a video frame sequence b312, a video frame sequence c313 of the video, and on the like. The visual preview area 311 is configured to display the video content in the selection interval. The user may adjust the selection interval of the video through a lateral sliding action on the visual preview area 311. The visual preview area 311 may provide real-time visual feedback to enable the user to visually see the adjusted video segment directly.

Similarly, if the target material includes an audio, the visual content included in the preview area includes a waveform corresponding to at least a part of the audio. The preview area at this time may be referred to as an auditory preview area.

As shown in the schematic diagram 300B of FIG. 3B, the visual content in an auditory preview area 321 includes a waveform 322 corresponding to at least a part of the audio. The auditory preview area 321 may show waveforms or other auditory elements within the audio selection interval. The user adjusts the selection interval of the audio through a lateral sliding based on the auditory preview area 321. The auditory preview area 321 may provide real-time auditory feedback to enable the user to hear the adjusted audio segment directly.

In some embodiments, the interactive element for the target material presented by the terminal device 110 corresponds to a sub-area of the preview area to indicate the selected part of the target material. The terminal device 110 presents the selected part of the target material in a sub-area of the preview area corresponding to the interactive element.

In some examples, an interactive element (sometimes referred to as an adjustable area) presented by the terminal device 110 corresponds to a sub-area of the preview area. The user is enabled to accurately adjust the size and range of the selection interval by dragging the interactive element, to provide an intuitive and accurate way to select the audio and video segments required by the user.

In some embodiments, the interactive element for the target material includes a first positioning control and a second positioning control. The first positioning control indicates a start of the selected part and the second positioning control indicates an end of the selected part. As shown in diagram 300C of FIG. 3C, the interactive element includes a first positioning control 331 indicating the start of the selected part, and a second positioning control 332 indicating the end of the selected part.

In some examples, the interactive element may have an explicit edging, such as an area with an edging. The edging may be adjustable to adjust the selected part. In other examples, the interactive element may also have no explicit boundary, but instead includes a first positioning control and a second positioning control. In still other examples, the interactive element may have both an edging and a positioning control.

The above is a pattern of interactive elements presented on the interface by the terminal device 110. The position of the interactive elements presented on the interface by the terminal device 110 will be described below.

In some embodiments, the position of the interactive element in the vertical direction (y direction) of the screen may be completely overlapped with the preview area or partially overlapped with the preview area, or not overlapped but above or below the preview area. In some embodiments, the position of the interactive element relative to the preview area is specified by a user input. In some examples, the terminal device 110 adjusts the starting point and the ending point of the selection interval in response to the user dragging the edge and/or the positioning control of the preview area. In other examples, the user may customize the height of the ordinate of the preview area to accommodate different using scenarios.

The terminal device 110 calculates and updates the value of the selection interval in real time when the user operation is received, and synchronously updates the display content of the visual preview area and the auditory preview area to ensure accurate reflection of the adjustment of the user.

In some embodiments, the terminal device 110 may further present a play control for the target material. In response to that a trigger on the play control is detected, the terminal device 110 plays the selected part of the target material. Referring back to the schematic diagrams 300A and 300B shown in FIGS. 3A and 3B, the terminal device 110 may present a play control 310 for the target material. The user 140 may click the play control 310 to view the selected material.

In some embodiments, the terminal device 110 receives an operation on at least one of the preview area or the interactive element. In some embodiments, in response to a completion of the operation, the terminal device 110 determines a target part for content generation in the target material. In some examples, the operation on at least one of the preview area or the interactive element from the user 140 may include, for example, a lateral sliding on the preview area, dragging an edge of the preview area, moving a positioning control, or the like. Then, if the operation of the user 140 is completed, the terminal device 110 determines a target part for content generation in the target material.

In some embodiments, the operation received by the terminal device 110 includes a sliding operation on the preview area, for example, an operation of the user sliding the preview area laterally. The terminal device 110 updates the visual content in the preview area from a first visual content associated with a first part of the target material to a second visual content associated with a second part of the target material according to the sliding operation. The second part is at least partially different from the first part.

In some examples, terminal device 110 may create a sliding view using any suitable software development tool, and internally render a thumbnail sequence of the video frames. The displayed thumbnail range is dynamically adjusted by a user interaction event (e.g., a touch sliding), thereby reflecting the adjustment of the selection interval.

In other examples, the terminal device 110 may utilize any suitable waveform display component that generates a waveform diagram according to the audio data. When the user performs the slide operation, the component synchronously updates the displayed waveform part to match the user-selected selection interval. The audio segment of the corresponding interval is played through the audio playing library when the user operates to provide instant audible feedback.

For example, the user 140 slides the preview area laterally, and the terminal device 110 receives the operation of the lateral sliding on the preview area of the user 140 to adjust the selection interval of the audio and video. If the operation of the lateral sliding on the preview area of the user 140 is completed, the terminal device 110 determines a target part for content generation.

In some embodiments, the operation received by the terminal device 110 includes a moving operation on at least one of the first positioning control or the second positioning control. In some examples, the terminal device 110, in response to the user moving the positioning control, adjusts the starting point and/or the ending point of the selection interval. For example, the user 140 moves the positioning control, and the terminal device 110 receives the operation of the moving on the positioning control of the user 140 to adjust the selection interval. If the dragging operation of the user is completed, the terminal device 110 determines a target part for content generation.

In some embodiments, the visual content in the sub-area corresponding to the interactive element presented by the terminal device 110 has a display pattern different from that of a visual content outside the sub-area. For example, the terminal device 110 uses different color elements for the display pattern of the visual content in the sub-area and the display pattern of the visual content outside the sub-area. For another example, the terminal device 110 selects to use a highlighted display pattern for the visual content in the sub-area, and a not highlighted display pattern for the visual content outside the sub-area.

Different display patterns include, but are not limited to, display patterns based on different colors, display patterns based on different fill patterns, display patterns based on different graphics, and any other display patterns capable of visually distinguishing from each other. The specific display pattern is not specifically limited in the embodiments of the present disclosure. The selection and configuration may be performed as needed in practical applications.

In some embodiments, the terminal device 110 updates the display pattern of the visual content in the sub-area corresponding to a moving track in the preview area according to the moving track indicated by the moving operation. The terminal device 110 updates the display pattern of the visual content in the sub-area corresponding to the moving track in the preview area according to the moving track formed by the moving operation of the user 140.

For example, the user 140 currently selects a video frame sequence b and a video frame sequence c of the video, and at this time, the terminal device 110 presents the display pattern corresponding to the video frame sequence b and the video frame sequence c as highlighted. If the user 140 slides the preview area and selects the video frame sequence a and the video frame sequence b, the terminal device 110 present the display pattern of the video frame sequence a and the video frame sequence b as highlighted and present the display pattern of the video frame sequence c of the video as not highlighted.

Hereinafter, a process for rendering a preview area will be described for ease of understanding. The preview area will be separated into an auditory preview area, a visual preview area, and an adjustable area for ease of understanding in the following description.

Rendering processes of an auditory preview area and a visual preview area are described hereinafter first.

In some embodiments, the terminal device 110 determines a content width of the target material according to a duration of the target material and one or more factors associated with a time-pixel conversion. The content width indicates a number of pixels needed to present the visual content associated with the entire target material.

In some embodiments, the one or more factors associated with the time-pixel conversion include at least one of: a playing rate of the target material, a scaling coefficient of visual content associated with at least a part of the target material, a number of pixels corresponding per unit time.

In some embodiments, the terminal device 110 determines a content offset value based on the starting time of the initially selected part of the target material and the one or more factors. The content offset value indicates the number of pixels offset from the starting position of the preview area to the starting position of the target material. Then, the terminal device 110 renders the visual content associated with a part of the target material in the preview area according to the content offset value and the predetermined width of the preview area.

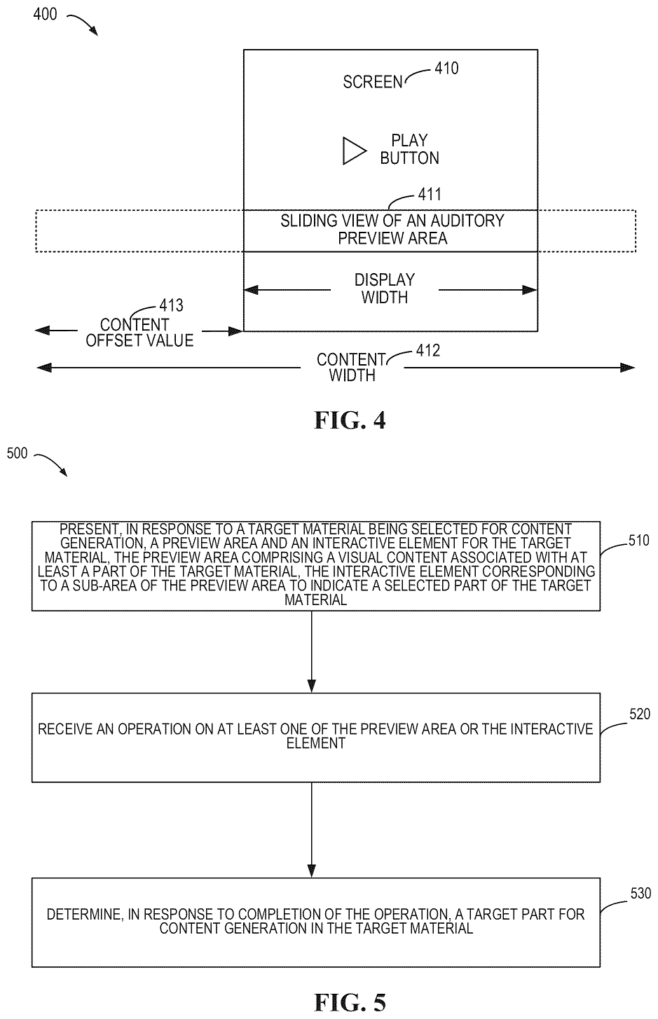

The rendering process of the auditory preview area is described first below with reference to FIG. 4. FIG. 4 illustrates a schematic diagram 400 of a process for rendering an auditory preview area according to some embodiments of the present disclosure.

The rendering of the auditory preview area includes the rendering of the audio waveform itself and also covers the layout and presentation of a container view carrying the waveform, while also includes the setting of a playing component. The container view carrying the waveform is a sliding view 411, wherein a display width of the sliding view 411 is the width of a screen 410, a content width 412 is the width of an audio source time code represented on the screen 410, and the content offset value 413 represents the content offset that the sliding view 411 scrolls based on an origin of the screen.

It is assumed that the background color of the sliding view 411 is a gradient from yellow to green for x=0 to x=containerWidth, the display width of the sliding view 411 is 100, and the content width is 300, and the content offset value is 100, then a part of the background color which is visible on the screen is a gradient of yellow changing from x=100 to x=200.

For ease of discussion, the variables used in the process of determining the auditory preview area rendering are first described.

In some examples, in a case that the preview area is initially presented, the starting time of the initially selected part of the audio may be considered as the source entry point of the audio segment (hereinafter denoted as audioStart) in seconds. The ending time of the initially selected part of the audio may be considered as the source exit point of the audio segment. 0(hereinafter denoted as audioEnd) in seconds.

The scaling coefficient of the visual content associated with at least a part of the audio (hereinafter denoted as zoomFactor) may affect a display density of the preview area. The audio playing rate (hereinafter denoted as playbackRate) may affect the play speed of the audio and the display of the preview area. The corresponding number of screen pixels per second (hereinafter denoted as pixelsPerSecond) is used to calculate the mapping of time on the screen. The margins of the preview area on both sides of the screen (hereinafter denoted as margin) are determined according to the pixels. The total width of the screen (hereinafter denoted as screenWidth) is determined according to the pixels.

The specific position and size of the container view in the editing interface are determined based on the total width of the screen, such as the following formula:

$$container X = margin \\ containerWidth = screenWidth - 2 * margin$$

where container X represents the starting position of the container view in the editing interface in pixels; and containerWidth represents the size of the container view in the editing interface in pixels.

The terminal device 110 creates a new sliding view as the container in the UI framework of the application, and sets its position and size according to the calculation result. This sliding view will be used to carry the rendered audio waveform, and provide a sliding function for user interaction. In addition, the player is integrated with the preview area. When the user clicks on the play button, the user may hear the audio segment effect of the selected interval, such as described above.

The content width of the sliding view (hereinafter referred to as contentWidth) may be calculated according to the playing duration of the audio, the playing rate playbackRate, the scaling coefficient zoomFactor, and the number of the screen pixels corresponding to each second pixelsPerSecond, reflecting the actual width of the audio on the screen:

$$contentWidth = \frac{audioDuration}{playbackRate} * zoomFactor * pixelsPerSecond$$

where audioDuration represents the duration of the audio material.

The content offset value (hereinafter referred to as contentOffset) is calculated according to the position of the starting time point of the audio on the screen, representing a content range that can be touched by the user through sliding the preview area:

$$contentOffset = ( \frac{audioStart}{playbackRate} * zoomFactor * pixelsPerSecond ) + margin$$

For example, assuming that there is an audio segment of which the audioStart is 60 seconds and the audioDuration is 120. The screen width is 1000 pixels, and the margin is 50 pixels, the playing rate playbackRate is set to 0.5 (half speed play), the scaling coefficient zoomFactor is 2, and the number of the screen pixels corresponding to each second pixelsPerSecond is 100.

In this case, the content width of the preview area may be: previewWidth=1000−2*50=900px. The corresponding starting position of the starting position of the preview area in the audio is audio

$$X = 50 + ( \frac{60}{0.5} * 2 * 100 ) = 2 \; 4050 px .$$

The content width of the audio is

$$audio Width = ( \frac{120}{0.5} * 2 * 100 ) = 48000 px .$$

An example flow of audio waveform rendering is described below. The waveform data is first extracted from the audio file, and the amplitude value for each time point is calculated, and these data will be used to render an audio waveform within the container view. Then, the position and the length of the waveform data in the container view (that is, the content width and the content offset value of the preview area) are calculated according to the audio playing rate playbackRate, the scaling coefficient zoomFactor, and the number of the screen pixels corresponding to each second pixelsPerSecond:

$$wave X = audio X \\ waveWidth = audioWidth$$

where wave X represents the starting position of rendering the waveform, and the waveWidth represents the width of the rendered waveform.

Finally, the extracted waveform data is used to connect the points in the container view through a Bezier curve or a straight line segment, in order to form a completed waveform diagram, and present the change in the loudness of the audio visually.

The rendering process of the visual preview area are described continually in the following. The rendering of the visual preview area intends to provide an intuitive interface, so that the user can clearly see the selection interval of the video content. This includes the layout and presentation of the container view carrying the video thumbnail, and the rendering of the thumbnail itself. For ease of discussion, the variables used in the process of determining the auditory preview area are first described.

In some examples, the starting time of the initially selected part of the video may also be referred to as a source entry point (hereinafter denoted as videoStart) of the video segment in seconds. The ending time of the initially selected part of the video may also be referred to as a source exit point (hereinafter denoted as videoEnd) of the video segment in seconds.

The zoom factor (hereinafter denoted as zoomFactor) of the visual content associated with at least a part of the video may affect the display density of the preview area. The video playing rate (hereinafter denoted as playbackRate) can affect the playing speed of the video and the display of the preview area. The number of the screen pixels corresponding to each second (hereinafter denoted as pixelsPerSecond) is used to calculate a mapping of time on the screen. The margins of the preview area on both sides of the screen (hereinafter denoted as margin) are determined according to the pixels. The total width of the screen (hereinafter denoted as screen Width) is determined according to the pixels.

The specific position and size of the container view in the editing interface are determined based on the total width of the screen screen Width and the predetermined margin. The calculation formula is:

$$container X = margin \\ containerWidth = screenWidth - 2 * margin$$

where container X represents the starting position of the container view in the editing interface in pixels; and the containerWidth represents the size of the container view in the editing interface in pixels.

The terminal device 110 creates a new sliding view as the container in the UI framework of the application, and sets its position and size according to the calculation result. This view will be used to carry the rendered video thumbnail and present a visual preview of the entire video segment.

The calculation of the content width and the content offset value is the same as the content width and the content offset value of the auditory preview area container view, and the difference point is that the sliding view content width and the content offset value of the visual preview area are calculated by the source time code, the source entry point and the source exit point of the video. The content width and the content offset value may be determined with reference to the above calculation steps, which will not be repeated here in the present disclosure.

An example flow of thumbnail rendering is described below. Firstly, an audio and video engine is used to extract key frames from a video file at a certain time interval to generate a series of thumbnails. This interval may be dynamically adjusted according to the scaling coefficient zoomFactor to adapt the user's view requirements of the user. Then, the position and size of each thumbnail in the container view are calculated to ensure that the thumbnail can accurately reflect the video content according to the video playing rate playbackRate, the zoom factor zoom Factor, and the number of the screen pixels corresponding to each second pixelsPerSecond.

Finally, a visual preview of the video is rendered within the container view using the extracted thumbnail. This usually includes arranging the thumbnails in chronological order to form a continuous visual stream, so that the user can visually see the content of each part of the video.

For example, assuming that there is one video segment, and its source entry point videoStart is 120 seconds, and the source exit point videoEnd is 360 seconds. The screen width is 1200 pixels, and the margin is 50 pixels, and the playing rate playbackRate is set to 1.0 (normal speed play), the scaling coefficient zoomFactor is 2, and the screen pixels corresponding to each second pixelsPerSecond is 100.

In this case, the preview area content width is containerWidth=1100px. The thumbnail generating interval is adjusted according to the scaling coefficient zoomFactor to provide a more dense or sparser visual preview, depending on the video length and scaling coefficient zoomFactor. The thumbnail is rendered in the container view, and reflects the video content from the 120th seconds to the 360th seconds, the user can obtain an intuitive overview of the video content through the order of thumbnails.

The rendering process of the adjustable area is described below. The key to the design of the adjustable area is to provide an intuitive interface, so that the user can adjust the selection interval of the video or audio material through gesture operation.

In some embodiments, the terminal device 110 determines, in response to the end of the operation, a target sub-area corresponding to the interaction element in the preview area. The terminal device 110 determines a first relative position of the starting position of the target sub-area in the content width of the target material and a second relative position of the ending position of the target sub-area in the content width. The content width indicates the number of pixels needed to present visual content associated with the entire target material.

Then, the terminal device 110 determines a starting time of the target part in the target material based on the first relative position and the one or more factors associated with the time-pixel conversion. Further, the terminal device 110 determines an ending time of the target part in the target material based on the second relative position and the one or more factors.

For ease of discussion, the variables used in the process of determining the adjustable area are first described. In some examples, a margin (hereinafter denoted as margin) of the preview area on both sides of the screen is determined according to the pixel. The total width of the screen (hereinafter denoted as screenWidth) is determined according to the pixels. The first relative position (sometimes denoted as a content offset value contentOffset) of the sliding view is determined according to the pixel. The content width of the sliding view (hereinafter denoted as contentWidth) is determined according to the pixel. The scaling coefficient (hereinafter denoted as zoomeFactor) may affect the display density of the preview area. The playing rate of the audio and/or video (hereinafter denoted as playbackRate) may affect the playing speed of the audio and/or video and the display of the preview area. The number of screen pixels corresponding to each second (hereinafter denoted as pixelsPerSecond) is used to calculate the mapping of time on the screen.

The initial position of the adjustable area is set as the margin of the preview area, the width is screenWidth-2×margin, and it is ensured that the adjustable area is aligned with the boundary of the preview area. The user may customize the y-coordinate and height of the adjustable area to accommodate different usage scenarios. If the user adjusts the adjustable area through the gesture operation, the size and the position of the area correspondingly change to provide instant visual feedback. This enables the user to intuitively adjust the starting point and the ending point of the selection interval.

After the gesture operation ends, the system calculates and updates the source entry point and the source exit point of the audio or video material according to the final position and size of the adjustable area. When calculating and updating the source entry point and the source exit point of the audio or video material, it is assumed that the value of margin is zero. For example, the new source entry point may be calculated by:

$$newStart = \frac{contentOffset}{( widthPerSecond / zoomFactor )} * playbackRate$$

where newStart represents the adjusted new source entry point, that is, the time of the selected part in the material.

New Source exit point:

$$newEnd = \frac{contentOffset + contentWidth}{( widthPerSecond / zoomFactor )} * playbackRate$$

where newEnd represent the new source exit point, that is, the time of the selected part in the material.

For example, consider a device with a screen width of 1000 pixels and a margin set to 50 pixels. Assuming that the user is editing a segment of audio, and the scaling coefficient zoomFactor is 2, and the playing rate playbackRate is 1 (normal speed play), and the number of screen pixels corresponding each second is 100.

Initially, the width of the adjustable area screenWidth-2×margin=900px. Assume that the user adjusts the adjustable area from a range of 100 pixels to 700 pixels of the screen through a gesture. After the gesture operation ends, the system needs to update the source entry point and the source exit point of the audio according to the new position and size of the adjustable area.

Assuming that contentOffset is 100 pixels (corresponding to the adjusted starting position), contentWidth is 600 pixels (corresponding to adjusted area width). According to the formula, the new source entry point is:

$$newStart = \frac{100}{( 100 / 2 )} * 1 = 2 second .$$

The new source exit point is:

$$newEnd = \frac{100 + 600}{( 100 / 2 )} * 1 = 14 second .$$

As can be seen from the above description, depending on the specific type of the target material (e.g., video, audio, image, etc.), the preview area may be a visual preview area or an auditory preview area. The interactive elements used to indicate the selected part may be implemented as adjustable areas. That is, in embodiments of the present disclosure, a component integrated with a visual preview area, an auditory preview area and an adjustable area is introduced. The component may intuitively display the audio and video content in the selection interval and support adjustment through simple dragging and sliding actions. This design not only simplifies the operation steps but also improves the intuitiveness and accuracy of the operation. Through the visual preview area, the user may intuitively see the selection interval of the video content and adjust in real time. Through the auditory preview area, the user may hear the selection interval of the audio content and adjust the audio content in real time. The design of these two areas enables the user to edit both visual and auditory content accurately. Further, the adjustable area enables the user to adjust the size and range of the selection interval, and provides a method for accurately adjusting the size of the selection interval. With this design, the user can precisely adjust the selection interval as needed without complex operations. In this way, the convenience and efficiency of content generation are improved.

In summary, through the integrated component for selection interval adjustment, the user can complete the complex selection interval adjustment task through a simple and intuitive operation, and the convenience of the operation is improved greatly. Accordingly, by means of the fine visual and auditory preview functions, the user may more accurately control the adjustment of the selection interval to ensure the accuracy of the final editing content and meet the precise requirements of the user. Further, through real-time auditory feedback, the user may preview the audio effect in real time when adjusting the selection interval, the sound adjusting process is greatly optimized, and the editing efficiency and the audio processing accuracy are improved.

### Example Processes

FIG. 5 illustrates a flowchart of a process 500 for content generation according to some embodiments of the present disclosure. Process 500 may be implemented at terminal device 110. The process 500 is described below with reference to FIG. 1.

At block 510, in response to the target material being selected for content generation, the terminal device 110 presents a preview area and an interactive element for the target material, the preview area including a visual content associated with at least a part of the target material, the interactive element corresponding to a sub-area of the preview area to indicate a selected part of the target material.

At block 520, the terminal device 110 receives an operation on at least one of a preview area or an interactive element.

At block 530, in response to completion of the operation, the terminal device 110 determines a target part for content generation in the target material.

In some embodiments, the process 500 further includes: presenting a play control for the target material; and in response to that a trigger on the play control is detected, playing the selected part of the target material.

In some embodiments, the target material includes a video and the visual content includes at least a portion of the frames of the video.

In some embodiments, the target material includes an audio, and the visual content includes a waveform corresponding to at least a part of the audio.

In some embodiments, the position of the interactive element relative to the preview area is specified by the user input.

In some embodiments, the operation includes a sliding operation on the preview area, and the process 500 further includes: updating, according to the sliding operation, the visual content in the preview area from a first visual content associated with a first part of the target material to a second visual content associated with a second part of the target material, the second part being at least partially different from the first part.

In some embodiments, the interaction element includes a first positioning control and a second positioning control indicating a start and an end of the selected part, respectively, and the operation includes a moving operation on at least one of the first positioning control or the second positioning control.

In some embodiments, the visual content in a sub-area corresponding to the interactive element has a display pattern different from that of a visual content outside the sub-area, and the process 500 further includes: updating, according to a moving track indicated by the moving operation, the display pattern of the visual content in a sub-area corresponding to the moving track in the preview area.

In some embodiments, determining the target part for content generation in the target material includes: in response to an end of the operation, determining a target sub-area corresponding to the interactive element in the preview area; determining a first relative position of a starting position of the target sub-area in a content width of the target material and a second relative position of an ending position of the target sub-area in the content width, the content width indicating a number of pixels required to present the visual content associated with the entire target material; determining a starting time of the target part in the target material based on the first relative position and one or more factors associated with a time-pixel conversion; and determining an ending time of the target part in the target material based on the second relative position and the one or more factors.

In some embodiments, presenting the preview area includes: determining a content width of the target material based on a duration of the target material and one or more factors associated with a time-pixel conversion, the content width indicating a number of pixels required to present the visual content associated with the entire target material; determining a content offset value based on a starting time of an initially selected part of the target material and the one or more factors, the content offset value indicating a number of pixels offset from a starting position of the preview area to a start of the target material; and rendering, in the preview area, a visual content associated with a part of the target material according to the content offset value and a predetermined width of the preview area.

In some embodiments, the one or more factors include at least one of: a playing rate of the target material, a scaling coefficient of the visual content associated with at least a part of the target material, or the number of pixels corresponding to each unit time.

### Example Apparatus and Device

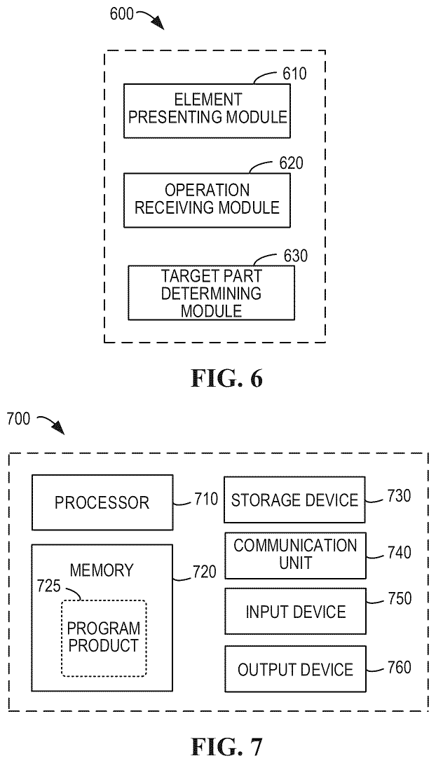

FIG. 6 shows a schematic structural block diagram of an apparatus 600 for content generation according to some embodiments of the present disclosure. The apparatus 600 may be implemented or included in a timing processing system 110. The various modules/components in the apparatus 600 may be implemented by hardware, software, firmware, or any combination thereof.

As shown, the apparatus 600 includes an element presenting module 610 configured to present, in response to a target material being selected for content generation, a preview area and an interactive element for the target material, the preview area including a visual content associated with at least a part of the target material, the interactive element corresponding to a sub-area of the preview area to indicate a selected part of the target material. The apparatus 600 further includes an operation receiving module 620 configured to receive an operation on at least one of the preview area or the interactive element. The apparatus 600 further includes a target part determining module 630 configured to determine, in response to completion of the operation, a target part for content generation in the target material.

In some embodiments, the apparatus 600 further includes a control presentation module configured to, in response to completion of the operation, determine a play control for a target part for content generation in the target material; and in response to that a trigger on the play control is detected, play the selected part of the target material.

In some embodiments, the target material includes a video and the visual content includes at least a portion of the frames of the video.

In some embodiments, the target material includes an audio, and the visual content includes a waveform corresponding to at least a part of the audio.

In some embodiments, the position of the interactive element relative to the preview area is specified by a user input.

In some embodiments, the operation includes a sliding operation on the preview area, and the apparatus 600 further includes a content updating module configured to update, according to the sliding operation, the visual content in the preview area from a first visual content associated with a first part of the target material to a second visual content associated with a second part of the target material, the second part being at least partially different from the first part.

In some embodiments, the interaction element includes a first positioning control and a second positioning control indicating a start and an end of the selected part, respectively, and the operation includes a moving operation on at least one of the first positioning control or the second positioning control.

In some embodiments, the visual content in a sub-area corresponding to the interactive element has a different display pattern different from that of a visual content outside the sub-area, and the apparatus 600 further includes a pattern updating module configured to update, according to a moving track indicated by the moving operation, the display pattern of the visual content in a sub-area corresponding to the moving track in the preview area.

In some embodiments, the target part determining module 630 is further configured to, in response to an end of the operation, determine a target sub-area corresponding to the interactive element in the preview area; determine a first relative position of a starting position of the target sub-area in a content width of the target material and a second relative position of an ending position of the target sub-area in the content width, the content width indicating a number of pixels required to present the visual content associated with the entire target material; determine a starting time of the target part in the target material based on the first relative position and one or more factors associated with a time-pixel conversion; determine an ending time of the target part in the target material based on the second relative position and the one or more factors.

In some embodiments, the element presenting module 610 is further configured to determine a content width of the target material based on a duration of the target material and one or more factors associated with a time-pixel conversion, the content width indicating a number of pixels required to present the visual content associated with the entire target material; determine a content offset value based on a starting time of an initially selected part of the target material and the one or more factors, the content offset value indicating a number of pixels offset from a starting position of the preview area to a start of the target material; and render, in the preview area, a visual content associated with a part of the target material according to the content offset value and a predetermined width of the preview area.

In some embodiments, the one or more factors include at least one of: a playing rate of the target material, a scaling coefficient of the visual content associated with at least a part of the target material, or the number of pixels corresponding to each unit time.

FIG. 7 shows a block diagram illustrating an electronic device 700 in which one or more embodiments of the present disclosure may be implemented. It should be understood that the electronic device 700 illustrated in FIG. 7 is merely exemplary and should not constitute any limitation on the functionality and scope of the embodiments described herein. The electronic device 700 shown in FIG. 7 may be configured to implement the electronic device 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of electronic device 700.

Electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a magnetic disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce an apparatus to implement the functions/acts specified in the flowchart and/or block diagram. These computer-readable program instructions may also be stored in a computer-readable storage medium, and these instructions cause the computer, programmable data processing apparatus, and/or other devices to function in a particular manner, such that the computer-readable medium storing instructions includes an article of manufacture including instructions to implement various aspects of the functions/acts specified in the flowchart and/or block diagram(s).

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in the flowchart and/or block diagram.

The flowchart and block diagrams in the drawings show architecture, functionality, and operation of possible implementations of systems, methods, and computer program products according to a plurality of implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, and they may sometimes be performed in the reverse order depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed herein. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for content generation, comprising:
in response to a target material being selected for content generation, presenting a preview area and an interactive element for the target material, the preview area comprising a visual content associated with at least a part of the target material, the interactive element corresponding to a sub-area of the preview area to indicate a selected part of the target material;
receiving an operation on at least one of the preview area or the interactive element; and
in response to completion of the operation, determining a target part for content generation in the target material.

2. The method of claim 1, further comprising:
presenting a play control for the target material; and
in response to that a trigger on the play control is detected, playing the selected part of the target material.

3. The method of claim 1, wherein the target material comprises a video, and the visual content comprises at least a portion of frames of the video.

4. The method of claim 1, wherein the target material comprises an audio, and the visual content comprises a waveform corresponding to at least a part of the audio.

5. The method of claim 1, wherein a position of the interactive element relative to the preview area is specified by a user input.

6. The method of claim 1, wherein the operation comprises a sliding operation on the preview area, and the method further comprises:
updating, according to the sliding operation, the visual content in the preview area from a first visual content associated with a first part of the target material to a second visual content associated with a second part of the target material, the second part being at least partially different from the first part.

7. The method according to claim 1, wherein the interactive element comprises a first positioning control and a second positioning control indicating a start and an end of the selected part, respectively, and the operation comprises a moving operation on at least one of the first positioning control or the second positioning control.

8. The method of claim 7, wherein a visual content in a sub-area corresponding to the interactive element has a display pattern different from that of a visual content outside the sub-area, and the method further comprises:
updating, according to a moving track indicated by the moving operation, the display pattern of the visual content in a sub-area corresponding to the moving track in the preview area.

9. The method according to claim 1, wherein determining the target part for content generation in the target material comprises:
in response to an end of the operation, determining a target sub-area corresponding to the interactive element in the preview area;
determining a first relative position of a starting position of the target sub-area in a content width of the target material and a second relative position of an ending position of the target sub-area in the content width, the content width indicating a number of pixels required to present the visual content associated with the entire target material;
determining a starting time of the target part in the target material based on the first relative position and one or more factors associated with a time-pixel conversion; and
determining an ending time of the target part in the target material based on the second relative position and the one or more factors.

10. The method of claim 1, wherein presenting the preview area comprises:
determining a content width of the target material based on a duration of the target material and one or more factors associated with a time-pixel conversion, the content width indicating a number of pixels required to present the visual content associated with the entire target material;
determining a content offset value based on a starting time of an initially selected part of the target material and the one or more factors, the content offset value indicating a number of pixels offset from a starting position of the preview area to a start of the target material; and
rendering, in the preview area, a visual content associated with a part of the target material according to the content offset value and a predetermined width of the preview area.

11. The method of claim 9, wherein the one or more factors comprise at least one of:
a playing rate of the target material,
a scaling coefficient of a visual content associated with at least a part of the target material, or
the number of pixels corresponding to each unit time.

12. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
in response to a target material being selected for content generation, presenting a preview area and an interactive element for the target material, the preview area comprising a visual content associated with at least a part of the target material, the interactive element corresponding to a sub-area of the preview area to indicate a selected part of the target material;
receiving an operation on at least one of the preview area or the interactive element; and
in response to completion of the operation, determining a target part for content generation in the target material.

13. The electronic device of claim 12, wherein the acts further comprise:
presenting a play control for the target material; and
in response to that a trigger on the play control is detected, playing the selected part of the target material.

14. The electronic device of claim 12, wherein the target material comprises a video, and the visual content comprises at least a portion of frames of the video.

15. The electronic device of claim 12, wherein the target material comprises an audio, and the visual content comprises a waveform corresponding to at least a part of the audio.

16. The electronic device of claim 12, wherein a position of the interactive element relative to the preview area is specified by a user input.

17. The electronic device of claim 12, wherein the operation comprises a sliding operation on the preview area, and the acts further comprise:
updating, according to the sliding operation, the visual content in the preview area from a first visual content associated with a first part of the target material to a second visual content associated with a second part of the target material, the second part being at least partially different from the first part.

18. The electronic device of claim 12, wherein the interactive element comprises a first positioning control and a second positioning control indicating a start and an end of the selected part, respectively, and the operation comprises a moving operation on at least one of the first positioning control or the second positioning control.

19. The electronic device of claim 18, wherein a visual content in a sub-area corresponding to the interactive element has a display pattern different from that of a visual content outside the sub-area, and the acts further comprise:
updating, according to a moving track indicated by the moving operation, the display pattern of the visual content in a sub-area corresponding to the moving track in the preview area.

20. A non-transitory computer-readable storage medium having a computer program stored thereon, the computer program being executable by a processor to implement acts comprising:
in response to a target material being selected for content generation, presenting a preview area and an interactive element for the target material, the preview area comprising a visual content associated with at least a part of the target material, the interactive element corresponding to a sub-area of the preview area to indicate a selected part of the target material;
receiving an operation on at least one of the preview area or the interactive element; and
in response to completion of the operation, determining a target part for content generation in the target material.
